(19) United States
(12) Patent Application Publication
(10) Pub. No.: US 2013/0075533 A1
(43) Pub. Date: Mar. 28, 2013

(54) Composites, Method for Preparation of Same and Flying Sails Containing Them

(71) Applicant: PORCHER INDUSTRIES, Badinieres (FR)

(72) Inventor: Stéphane VERAN, Aix Les Bains (FR)

(73) Assignee: PORCHER INDUSTRIES, Badinieres (FR)

(21) Appl. No.: 13/623,965

(22) Filed: Sep. 21, 2012

(30) Foreign Application Priority Data
Sep. 21, 2011 (FR) 1158412

(51) Int. Cl. B64D 17/02

(52) U.S. Cl. CPC B64D 17/02
USPC 244/145; 428/76

(57) ABSTRACT

This invention relates to a composite comprising two polyurethane films, identical or different, that are connected to one another and between which a reinforcement mesh and at least one textile reinforcement thread oriented according to at least one predetermined stress line is inserted. The invention also relates to sails including such a composite.

The invention relates to new composites, in particular for the preparation of a sail, for example flying sails, the method for preparation of same and the sails, for example flying sails, obtained.

In the field of flying sails, for example paragliding sails, the manufacturers of fabrics have for a long time sought to combine various properties such as, in particular, lightness, mechanical performance, resistance to aging and compactness. To this end, they try to start with a lightweight, resistant, flexible fabric, in particular to limit the marking of the fold, and with a low thickness. It is still difficult today to obtain a fabric having all of these optimized properties.

For the design of flying sails, it is in particular routine to use textiles that are produced from polyamide or polyester threads and coated with polymer compositions, in general silicone, melamine/formol, polyurethane or acrylic. The combination of these two materials makes it possible to confer the required mechanical properties (e.g. resistance to tearing, dimensional stability) and porosity for the application. However, the coated fabrics have a certain rigidity and do not have good resistance to aging. Moreover, these textiles may have a fold memory or marking (blank line at the fold). Furthermore, as the fabrics are traditionally produced by crisscrossing warp threads and weft threads, the pieces of fabric coated and fashioned to form the paraglide sail have a recurrent problem referred to as diagonal stretch, i.e. in a direction inclined with respect to the warp and weft directions. In this direction, the threads forming the base fabric do not confer the required elongation resistance, hence the routine need for a coating that provides stiffness and diagonal stretch resistance. This coating nevertheless has disadvantages, which are, in particular, rigidification of the coated fabric, reduced tear resistance, increased weight, and increased fold markings

Moreover, the paraglide sails are equipped with suspension lines, of which the stresses at the portions of the sail to which these lines are attached must be taken up. It is commonplace to have a certain number of these suspension lines so as to distribute these stresses. However, these suspension lines have a direct effect on drag and therefore the performance of the canopy. The coated fabrics currently used do not make it possible to significantly reduce the number of suspension lines due to the excessive stresses that such a reduction would place on the portions of the canopy to which they are attached.

An objective of this invention is to provide a composite that is lightweight, flexible, mechanically resistant (tear resistance, stretch resistance) and foldable, that can be used to produce sails, for example flying sails.

Another objective of the invention is to provide such a composite for which the stretching in the direction of stresses or constraints is reduced.

Another objective of the invention is to provide such a composite that has beneficial flexibility properties.

Another objective of the invention is to provide such a composite that has very little or no fold memory or marking.

Another objective of the invention is to provide such a composite having good resistance to aging and in particular preserving good stability on stretching in the direction of stresses.

Another objective of the invention is to provide such a composite that makes it possible to reduce the number of suspension lines in the flying sails.

Another objective of the invention is to provide a sail, for example a flying sail, having all of these properties.

These objectives as well as others are satisfied by the subject matter of the invention, which is a composite comprising two polyurethane films (hereinafter referred to as PU films), identical or different, connected to one another (for example, laminated or welded) and between which at least one reinforcement mesh and at least one textile reinforcement thread oriented according to at least one predetermined stress line is inserted.

The combination of the two films and the reinforcement mesh makes it possible in particular to obtain a lightweight composite for a greater mechanical resistance than that of the more effective materials used for flying sails. This combination also makes it possible to obtain a stretch, in the direction of stresses, that is very effective and durable, generally less than 2%, preferably less than 1%, although it can be up to 10% for fabrics coated with polyurethane after aging. Thus, the composites according to the invention are durably flexible, while their stretch does not increase over time, unlike the coated fabrics of the prior art, which, stiff at the outset, become more flexible with time and lose their diagonal stretch resistance.

According to an embodiment, the two PU films of the composite according to the invention are made of the same material, i.e. they are identical in composition. According to another embodiment, the two PU films have a different composition. According to another embodiment, the two PU films have the same composition but different thicknesses. According to another embodiment, one of the PU films has a particular appearance, for example it has a decoration or an aluminum deposit or another metal coating, in particular obtained by the routine vacuum techniques.

The polyurethane films are polyurethane films or polyurethane-based films. By polyurethane-based film, we mean a film that includes at least one polymer including at least one urethane function; such films may, for example, include polyurethane and at least one other constituent, for example at least one other monomer or at least one other polymer or include at least one urethane function and at least one other constituent, for example at least one other monomer or at least one other polymer. These polyurethane-based films are generally copolymers.

Such polyurethane-based films are in particular polyurethane copolymers with at least one other polymer, in particular of the polyether and/or polyamide type. These copolymers are preferably block copolymers. As a non-limiting example, it is possible to cite polyurethane-block-polyether copolymers, polyurethane-block-polyamide copolymers or polyurethane-block-polyether-block-polyamide copolymers.

A polyurethane comprises a stiff portion (isocyanate) and a flexible portion (polyol). The ratio between these two components makes it possible to obtain a more or less stiff polymer.

By isocyanate, we mean both an isocyanate and a polyisocyanate, alone or in a mixture with one or more other isocyanates and/or polyisocyanates. The term “isocyanate” must be understood as including the terms “isocyanate” and “polyisocyanate”.

The polyurethane is preferably an aromatic or aliphatic polyether- or polyester-based polyurethane. Thus, the polyurethane comprises a polyol portion of the polyether or polyester type and an aromatic or aliphatic isocyanate portion (linear or branched).

In a particular embodiment, the polyurethane is an aromatic polyether-based polyurethane.

In another embodiment, the polyurethane is an aliphatic polyether-based polyurethane.

In another embodiment, the polyurethane is an aliphatic polyester-based polyurethane.

In general, a person skilled in the art is well aware of the field of polyurethanes and is capable of proposing film compositions according to the invention.

Also by way of a non-limiting example, the thickness of each of the PU films is typically on the order of some ten micrometers, for example between 5 and 50 μm, and preferably between 5 and 25 μm.

Preferably, the PU films have a high elongation at break, in particular greater than or equal to 100%, and preferably between 150 and 200% (measured according to ISO standard 527-3).

Preferably, the PU films have an elastic modulus of between 10 and 100, and preferably between 10 and 40 MPa.

By contrast, polyester films, also used to prepare composites similar to those of the invention, have a low elongation at break, generally less than 10% and are relatively stiff, with a high elastic modulus, generally above 3000 MPa. Thus, the PU films of the invention are much more flexible than the polyester films and make it possible to obtain a non-breaking complex not having fold markings

Advantageously, the weight of each of the PU films is between 5 and 25 g/m², preferably between 8 and 20 g/m², for example between 10 and 15 g/m².

Advantageously, the other elements forming the composite, in particular the reinforcement mesh and threads), placed between the two PU films, are designed so as to enable the two PU films to come into contact with one another over a certain surface. This surface is sufficient to enable a bond between the two PU films, without the insertion of other constituent elements over the entire surface. In other words, according to a feature of the invention, the PU films are connected to one another (for example, laminated or welded).

Welding is an optimal embodiment in which there is no insertion of an adhesive between the faces of the PU films in contact with one another. In a particularly preferred embodiment, the PU films are therefore welded, one in contact with the other.

In the composite, the mesh is intended to mechanically reinforce the attached PU films, typically by increasing the tear resistance of the composite. More generally, the crisscrossing of threads gives the mesh mechanical resistance properties that are different according to the direction in the plane of the mesh, depending on the shape of the basic pattern of this crisscrossing.

The mesh forming the composite according to the invention may include an assembly of rectilinear threads arranged one with respect to another by repeating, regularly in the plane of the mesh, a pre-established basic pattern.

In one embodiment, this pattern includes threads crossing with an angle of between 45° and 90°, in general at 45° and/or at 90°. This pattern may, for example, consist of a parallelepiped completed with one and preferably both of its diagonals. This pattern may, for example, be diamond-shaped, completed with one of its diagonals or both of its diagonals. In other words, by regular repetition of the aforementioned pattern, in both directions defined by the plane of the mesh, this entire mesh is obtained. Thus, the different threads forming the mesh are positioned one with respect to another according to a pre-established shape, both in relative orientation and in relative spacing in the plane of the mesh.

According to an embodiment, two meshes are superimposed. Preferably, these meshes are arranged in a complementary manner, i.e. so as to provide the entire assembly with threads oriented in different directions.

The basic role of the reinforcement mesh(es) is to confer strength on the two joined PU sheets. The reinforcement mesh(es) are also capable of ensuring themselves or of helping (with the above-described reinforcement threads) to take up the stresses exerted on the sail. This role can in particular be satisfied essentially with a portion of the threads forming a mesh, for example the diagonals.

Preferably, and by way of a non-limiting example, the threads forming the mesh are made of polyester, aramid, carbon and so on. In the same mesh, the threads made of different respective materials and with different respective counts may be mixed.

Preferably, the threads of the mesh are crisscrossed as in a fabric, with certain threads acting as weft threads, while other threads act as warp threads. Alternatively, the threads to not crisscross, but are superimposed, by being distributed in at least two superimposed layers. As the case may be, the threads are, at their crisscrossing or at their overlapping, laminated or welded to one another. For a detailed example, a person skilled in the art may consult document EP-A-1 111 114.

The thickness of the mesh is equal to the thickness of the threads for most of this mesh, with the exception of occasional areas where at least two of the threads crisscross or overlap, in the direction Z, in which areas the thickness of the mesh is locally increased to a maximum of as many times as the number of threads that overlap. By way of a non-limiting example, the thickness of the threads, and therefore the thickness of the mesh, aside from the areas of overlapping of a plurality of threads, may be on the order of one hundred or several hundreds of micrometers, or even more, in particular depending on the thread counts. This thickness can thus be between 50 and 300 μm, and preferably between 100 and 250 μm.

The mesh may, for example, be flat.

Advantageously, the weight of the mesh is between 5 and 50 g/m², and preferably between 10 and 30 g/m².

Also advantageously, the mesh has an opening enabling the two PU films to come into contact with one another over a sufficient surface to ensure their attachment connecting the two PU films to one another, in particular by welding or lamination. It is therefore possible to vary the opening of the mesh in certain proportions, while keeping a sufficient contact surface between the two PU films and using a mesh providing the expected properties. Optimally, the opening of the mesh may range from 2 to 20 mm, and preferably from 4 to 15 mm(average dimension of the sides of the openings defined by the mesh).

The textile reinforcement thread is intended to transfer stresses, with the threads being oriented according to predetermined stress lines.

In one embodiment, the reinforcement thread(s) is (are) arranged according to the stress lines of the suspension lines. Thus, each of the threads extends in length, in the plane of the composite of the sail, in a specific longitudinal direction, or as the case may be, curved.

The threads are individual threads, in the sense that, before assembly of the composite, these threads are mechanically independent of one another.

The threads include, or even consist of, a whole body that extends in length in a predetermined direction.

In one embodiment, the invention therefore relates to an internal partition (inter-cell wall) intended to be connected to at least one suspension line or comprising at least one suspension line or comprising at least one point of attachment of a suspension line. In this embodiment, the partition is produced in the composite according to the invention and comprises at least one reinforcement thread intended to take up the stresses resulting from the suspension line. In particular, the at least one reinforcement thread extends from a point of attachment or contact with the suspension line.

In one embodiment, the reinforcement thread has a circular cross-section.

In another embodiment, the reinforcement thread has an oblong transverse cross-section, i.e. a transverse cross-section that is longer than it is wide, of which the width, in other words the maximum thickness (e) of the thread when it is considered in the composite is less than 0.06 times, preferably less than 0.05 times its maximum length (l), i.e. 0.06 times, preferably 0.05 times, the width of the thread when the latter is considered in the composite, with the understanding that the length of the aforementioned thread corresponds to the dimension of this thread according to its longitudinal direction in the composite. Owing to their flat conformation, the individual reinforcement threads according to the invention do not produce a significant variation in the total thickness of the composite, in the direction in which the low variation in this thickness, in the areas where at least one of these threads extends, is accommodated by the rest of the composite, in particular by the two polyurethane films, without the risk of delamination of these films. The flat threads also have the advantage of conferring great flexibility on the composite, and therefore on the sail or sail elements (in particular the internal partition) including said composite, while avoiding rigidifying it locally. Moreover, the external relief of the composite, resulting from the presence of flat reinforcement threads, is very minor, and even barely-existent. This presents an advantage for sails including this type of composite since this creates only very little, if any, resistance by friction with the wind. Moreover, even in the regions of the sail where two or more flat reinforcement threads are superimposed, the cumulative thickness of the constituents of the sail remains moderate: thus, the cohesion between the different reinforcement threads and the mesh is maintained without discontinuity of material between the two laminated films.

The textile reinforcement thread(s) is (are) arranged in the composite so that, in the transverse cross-section, the width of the oblong contour of its whole body extends in the superposition direction.

These so-called “flat” threads have the advantage of optimizing their contact surface with the PU films and of reducing the thickness of the composite.

Preferably, the textile reinforcement threads include an assembly of filaments, said filaments being produced either of an organic material, in particular aramid; polyamide; polyester, for example aromatic polyester such as Vectran®; or polyethylene, for example high-density polyethylene (HDPE) or polyethylene naphthol (PEN), such as Pentex®; or an inorganic material, in particular carbon.

The reinforcement threads have a suitable breaking resistance, in particular between 50 and 800 N, according to ISO standard 527-3, with the resistance value being capable of varying according to the nature of the organic material and the thread count.

Advantageously, the whole body of the thread is coated at the core and/or exterior. A coating may be foreseen in a way inserting it between the filaments constituting the thread thus forming a cohesion binder between these filaments.

Advantageously, the filaments at the periphery of the whole body may be coated, with the coating thus forming a sheath coating the whole body.

This binder and this sheath are advantageously involved in holding the filaments in place in the whole body. Advantageously, the specific function of the binder is to limit, or even prevent, infiltrations of water by capillarity in the whole body. The sheath makes it possible to facilitate the use of the thread, in particular by enabling its winding and/or by improving its physicochemical integration in the composite.

The coating material(s) used to form the binder and the sheath are identical or different, preferably identical, and are chosen among the polymers, in particular acrylic-, polyurethane- or polyethylene-based. Preferably, they are chosen from among the polyether-, aliphatic- or aromatic-based polyurethanes. Preferably, they are of the same type as, or even identical to, the PU films.

The coating content of the whole body of the reinforcement thread, defined as one hundred times the ratio between, on the one hand, the difference between the count of the coated thread and the count of the non-coated thread and, on the other hand, the count of the non-coated thread, is between 5 and 100%. It is preferably less than 50%, in particular in order to reduce the weight of the composite and therefore of the sail containing said composite.

Advantageously, if the filaments are made of aramid, the whole body has a ratio of between, on the one hand, its count expressed in dtex, and, on the other hand, its circumference or the maximum length of its oblong contour, expressed in millimeters, of which the value is less than 1000, as the case may be in the presence of coating material with a coating content of less than 50%. In practice, various methods for producing a flat reinforcement thread according to the invention can be envisaged by the specialists of the field, without going beyond the context of this invention. As an example, one of these methods involves starting with a pre-existing thread with a substantially circular cross-section, then subjecting it to one or more flattening operations, accompanied, as the case may be, by coating operations, in particular sizing operations. With regard to the coating, a person skilled in the art, by way of a detailed example, may refer to document US-A-2010/0089017. Alternatively, the thread may be produced directly from filaments, in particular by arranging them one with respect to another so as to obtain the structure described above. In any case, a flattened or flat thread is used, advantageously capable of being wound and stored for its subsequent use, in particular in order to produce the composite of the invention.

According to an optional feature, the composite includes a fabric (reinforcement fabric) placed inside the composite, in particular in contact with one of the PU films, e.g. between the reinforcement mesh and one of the PU films. This fabric is arranged with respect to only a portion of the composite, for example, at an edge or a corner. The fabric is intended to locally reinforce the composite, for example at the point of attachment of the suspension lines, or to form a portion enabling an assembly sewn with fabrics traditionally used in the envisaged application, for example in paragliding, in particular for the diagonal partitions, the lower portion (intrados), the upper portion (extrados), and the leading edge. The reinforcement fabric may be similar to those normally used in the envisaged application, for example polyamide or polyester thread fabrics, coated with polymer compositions, in general melamine/formol, polyurethane or acrylic. These fabrics may simply be raw (non-treated, non-coated). The fabric is secured to the other components of the composite by a suitable adhesive, preferably PU-based. It may have previously been sized with a PU adhesive capable of being reactivated. This addition of localized adhesive will not cause a significant increase in the weight of the paraglide.

The composition according to the invention may also be subjected to an anti-UV treatment.

The composite according to the invention may also have a surface coating, in particular on one side, which will often be the visible exterior side once the composite is implemented in a sail. This coating may be decorative and/or an anti-UV protective coating. In one embodiment, the composite is intended to form the leading edge of a paraglide sail, and the composite comprises a reflective coating, for example an aluminized coating.

This invention also relates to a sail including at least one composite according to the invention. The sail is preferably a flying sail. By flying sail, we mean any type of sail with an aircraft engine, inflatable by the wind, for example a paraglide, a parachute, a hot air balloon, a kite surf, a kite, an airship, and so on.

In general, it is possible to define in a paraglide:

its leading edge, which represents the portion of the aerodynamic profile of the sail that first comes into contact with the air;

its trailing edge, which, in the direction of air flow, represents the rear, thinned portion of the aerodynamic profile of a sail;

the partitions (internal diagonal partitions or inter-cell walls) defining each cell forming the sail;

the upper portion or extrados, which is the upper portion of the sail having a convex camber;

the lower portion or intrados, which is the internal portion of the sail, which is flat or has a concave or slightly concave camber;

the suspension lines, which enable the sail to be directed.

This invention relates in particular to a paraglide sail of which the leading edge and/or the partitions are composites according to the invention. Preferably, the leading edge is a composite according to the invention for which the polyurethane is an aliphatic polyester-based polyurethane. Preferably, the partitions are composites according to the invention for which the polyurethane is an aromatic or else an aliphatic polyether-based polyurethane.

In one embodiment, the paraglide sail has a leading edge formed by a composite according to the invention.

In one embodiment, the paraglide sail has suspended partitions formed by a composite according to the invention, as described above.

In one embodiment, the paraglide sail has a leading edge made of a composite according to the invention and suspended partitions made of a composite according to the invention. The non-suspended partitions may be made of a material traditionally used, such as coated fabric. These partitions may also be made of a composite according to the invention not including a textile reinforcement thread.

The lower and upper potions are traditionally made of fabric. Above, it was mentioned that it is possible to sew the fabric portions to the composite portions, in particular composite portions including the fabric reinforcement insert according to the invention.

In one embodiment, the sail includes composite swatches comprising reinforcement fabric forming areas connected by sewing and/or areas for attachment of suspension lines.

In one embodiment, the lower and/or upper portions may be partially or entirely formed by a simple PU film, as described in the invention, for example 30 to 40 g/m², with this PU film being capable of being welded by heating with the composite according to the invention. In particular, the sail will then comprise a leading edge made of composite according to the invention. It may also be comprised of composite partitions, including suspended composite partitions.

Advantageously, the composites forming the partitions are perforated, and preferably micro-perforated.

Advantageously, the use of composites according to the invention in the sails makes it possible to reduce the number of suspension lines. Preferably, the number of suspension lines for each partition reinforced by reinforcement threads and suspended is between 2 and 4, and is preferably 2 or 3.

Advantageously, the use of reinforcement threads for the suspended sail partitions makes it possible to reduce the number of points of attachment of the suspension lines and therefore limit the drag in flight.

This invention also relates to a method for preparing a composite according to the invention.

The composite according to the invention may be prepared as follows:

(a) a first PU film is provided;

(b) at least one technical reinforcement thread is deposited;

(c) a reinforcement mesh is deposited;

(d) then a second PU film is deposited on the mesh.

Steps (b) and (c) may be inverted.

Between steps (c) and (d), for example, it is possible to add a step of insertion of a reinforcement fabric.

An alternative of this method consists of pre-positioning the mesh and the textile reinforcement threads between the PU films, then forcing the attachment of these films for example by creating a depression between them.

In each of these methods, the PU films are held together by any suitable means, for example by lamination, with the adhesive being capable of being provided externally or being impregnated in one and/or the other of the films. A PU adhesive is advantageously used. Preferably, the PU films are held together by heat welding, with the method therefore including an additional step of heating under pressure enabling heat welding of the polyurethane films. The welding may also be performed by ultrasound or any other means making it possible to ensure sufficient heating to produce the welding.

The invention will be easier to understand in view of the following description, provided solely by way of an example, and in reference to the drawings, wherein:

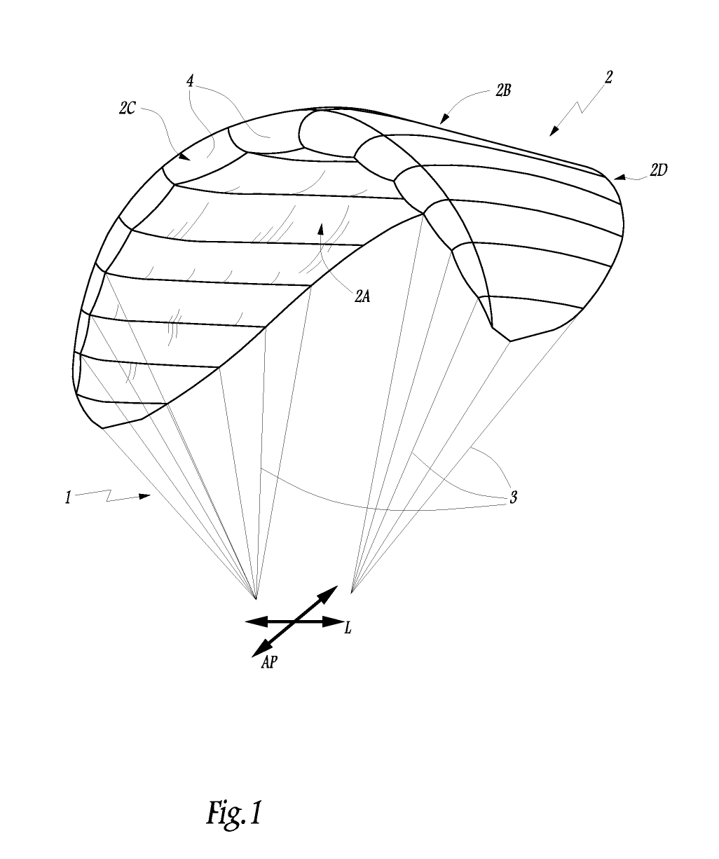

FIG. 1 is a diagrammatic perspective view of a paraglide;

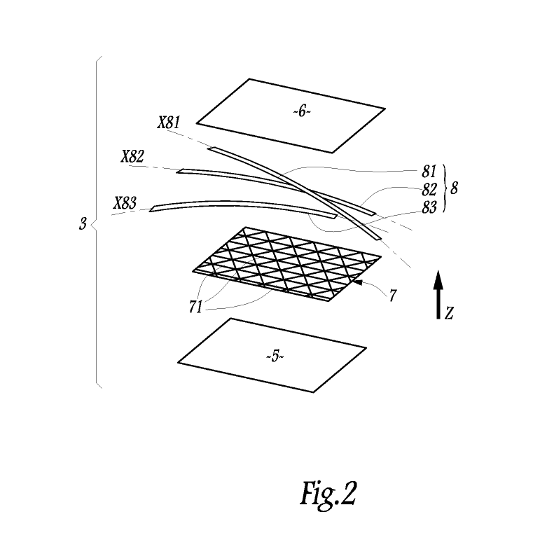

FIG. 2 is a diagrammatic exploded perspective view, showing the constituents of the composite;

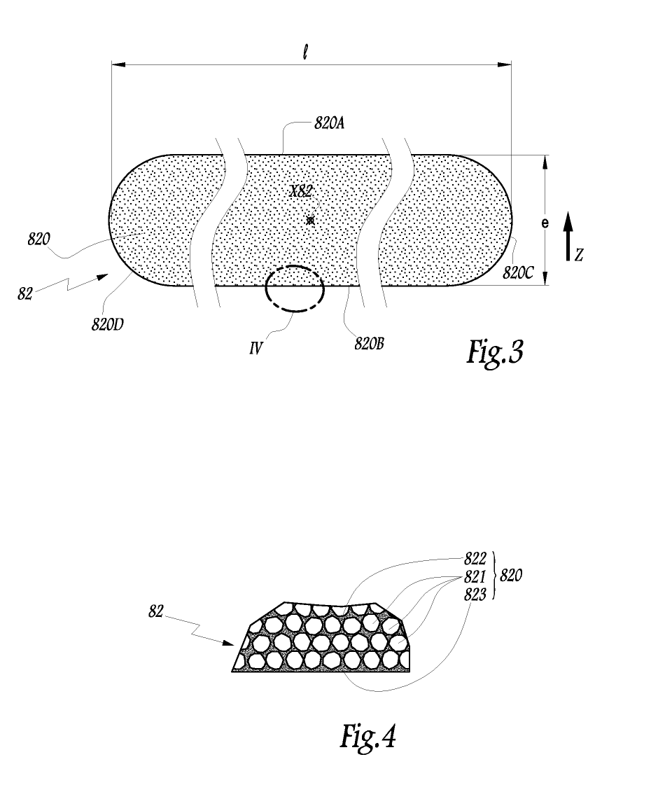

FIG. 3 is a diagrammatic cross-section according to plane III of FIG. 2;

FIG. 4 is a diagrammatic view, on a larger scale, of the circled area IV in FIG. 3;

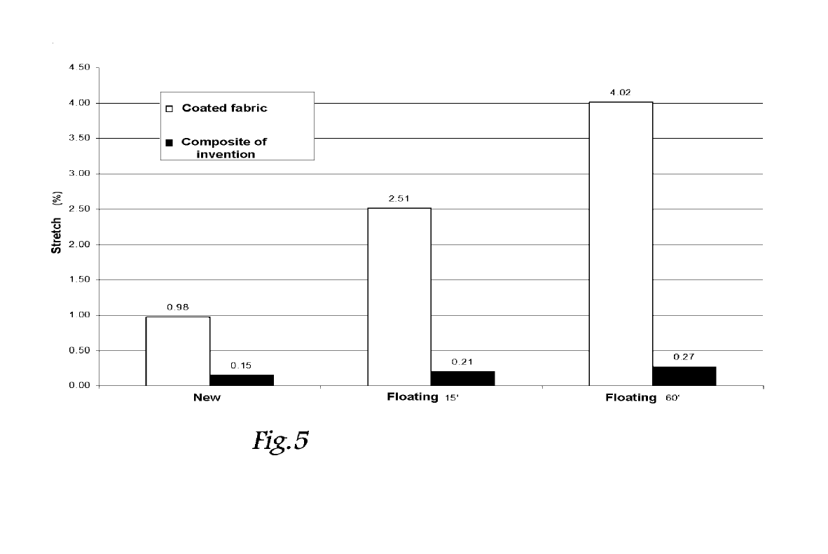

FIG. 5 shows the change in elongation according to the direction of stress under 3 lbs (1.36 kg) as a function of floating time for a coated polyurethane fabric and for a composite according to the invention.

FIG. 1 is a diagrammatic perspective view of a paraglide (1) including a sail (2) and suspension lines (3). The sail (2) has a lower portion (2A) and an upper portion (2B). At the front of the sail, the upper portion (2B) has a leading edge (2C).

Between the lower portion and the upper portion, anterior-posterior cells (2D) are defined, which lead toward the front to the leading edge (2C), and which are separated in pairs, according to the lateral direction, by inter-cell walls or partitions (4).

As is clearly visible in FIG. 2, the composite includes at least 4 superimposed layers, namely two opposing polyurethane films 5 and 6, constituting the two opposing faces of the composite, as well as, between these films 5 and 6, a mesh 7 and textile reinforcement threads in the form of a layer 8 consisting of a plurality of individual threads, of which there are three in the example shown in FIG. 3, respectively referenced 81, 82 and 83. In FIG. 2, Z designates the rectilinear direction corresponding to the thickness of the composite: thus, according to this direction Z of superpositioning, the film 5, the mesh 7, the layer 8 of threads 81, 82 and 83 and the film 6 are located in succession. In the assembled state of the composite, while this composite is spread flat on a planar surface, the different layers constituting the composite generally extend in a plane perpendicular to the direction Z.

When the composite is contained in a sail, it must be understood that it generally has a three-dimensional shape, with a more or less dished shape when the sail is in operation.

The mesh 7 includes or, as in the example of FIG. 2, even consists of an assembly of rectilinear threads 71 arranged one with respect to another, repeating, regularly in the plane of the mesh 7, a basic pre-established pattern. Thus, in the example of the embodiment considered in FIG. 2, this pattern consists of a diamond-shape completed with each of its diagonals. In other words, by a regular repetition of the aforementioned pattern, in both directions defined by the plane of the mesh 7, the entirety of this mesh is obtained. Thus, the different threads 71 constituting the mesh 7 are positioned one with respect to another according to a pre-established shape, both in relative orientation and in relative spacing in the plane of the mesh.

In the context of a sail including a composite according to the invention, each of the threads 81, 82 and 83 extends in length, in the plane of the sail, in a specific longitudinal direction X81, X82, X83, as the case may be curved, as shown in FIG. 2. In a manner known per se, each of these threads 81, 82, 83 thus follows, according to its longitudinal direction X81, X82, X83, a pre-established trajectory, along which it has been predetermined, in particular by preliminary ad hoc calculations, that significant stresses will be applied to the sail when this sail is in operation. Thus, the stresses applied to the composite forming the sail are then essentially or almost entirely withstood by one or more of the threads 81, 82 and 83, which are consequently dimensioned.

Of course, it is understood that, in practice, the total number of reinforcement threads, similar to the threads 81, 82 and 83, in the composite is generally much greater than three.

Thus, the thread 82 includes, and, as in the example considered here, even consists of a whole body 820 (FIG. 3) that extends in length according to direction X82, while being substantially centered on an axis geometrically representing the direction X82. As is clearly visible in FIG. 3, the thread 82 does not have, in the cross-section transversal to its longitudinal direction X82, a circular or even close to a circular profile, as might be expected for a textile reinforcement thread traditionally used in the field concerned here. Instead, the transverse cross-section of the whole body 820 of the thread 82, i.e. its cross-section in a geometric plane perpendicular to its longitudinal direction X82, has an oblong shape, i.e. a shape that is significantly longer than it is wide. When considering the thread 82 according to is whole volume, this means that the body 820 has a width significantly greater than its thickness, with the understanding that the thickness of the thread is its dimensions considered in the direction Z, whereas its width is the dimension that, in the plane of the composite, is perpendicular to the longitudinal direction X82. Thus, in FIG. 2, l designates the length of the oblong cross-section of the whole body 820 of the thread 82, while e designates the width of this oblong cross-section, respectively in reference to the width and the thickness of the thread 82.

Thus, the thread 82 may be qualified as a flat or flattened thread, which, in the sense of this document, means that the ratio ell between its thickness and its width, i.e. the ratio between the maximum width and the length of the oblong cross-section of its whole body 820 is less than 0.06, and preferably even less than 0.05. In practice, the flat or flattened shape of the whole body 820 of the thread 82 is associated with the constitution of this whole body. Indeed, as diagrammatically shown in FIG. 4, the body 820 is not a unitary piece, but results from the agglutination of a large number of basic filaments 821: each of these filaments 821 may be individually separated from the others and, in this sense, may therefore be described as a monofilament.

Individually, it may be considered that each of these filaments 821 has, in the cross-section transversal to the axis X82, a substantially circular cross-section, with a diameter on the order of some ten micrometers, in particular between 3 and 30 μm. When these filaments 821 are considered in the agglutinated state in the whole body 820, these filaments 821 are arranged one with respect to another so as to confer on this whole body 820 the oblong cross-section described above, noting that some hundreds, and even one or several thousands of filaments, in other words at least two hundred, or even at least one thousand filaments, are thus agglutinated so as to form the whole body 820. The result is that the thickness e of the whole body 820 is on the order of one-tenth of a millimeter, which means that, according to the direction Z, some ten filaments 821 are located in succession over the thickness of the whole body 820. More specific quantitative examples will be provided below.

Advantageously, according to the embodiment shown in FIGS. 3 and 4, the whole body 820 of the thread 82 is sized, at the core and/or externally. More specifically, as diagrammatically shown in FIG. 4, a coating material is inserted between the filaments 821, thus forming a binder 822 for cohesion between these filaments. In addition, a coating material is provided so as to envelop the filaments 821 located at the periphery of the whole body 820, so as to form a sheath 823 for coating this body 820.

In practice, various shapes can be envisaged for the transverse cross-section of the whole body 820, once these shapes have an oblong contour. Thus, in the embodiment diagrammatically shown in FIG. 3, the contour of the transverse cross-section of the whole body 820 has two substantially flat opposing segments 820A and 820B, between which the width of its contour is defined, in other words, the thickness e of the whole body 820. This means that the segments 820A and 820B extend substantially perpendicularly to the direction Z, while being offset by the distance e. The respective ends of these flat segments 820A and 820B are connected in pairs by two opposing segments 820C and 820D of the transverse contour of the whole body 820, these segments 820C and 820D being convex, in particular by continuously connecting the flat segments 820A and 820B. Of course, the segments 820A and 820B are not strictly flat, in the sense that they are defined by a succession of filaments 821 located at the periphery of the whole body 820, as the case may be by being covered by a portion of the sheath 823. The advantage of this embodiment is that the thickness e of the whole body 820 has a substantially constant value over most of the width of this body, in particular without having, in the direction of the width of the body 820, a local maximum value. This means that the flat or flattened shape according to the invention is thus optimized.

That said, as an alternative not shown, the oblong contour of the transverse cross-section of the whole body 820 may correspond substantially to an ellipse or, more generally, to a substantially elliptical contour, which is centered on an axis geometrically representing the direction X82 and of which the small axis extends according to direction Z. In this case, the ratio between the maximum width and the maximum length of this contour corresponds to the ratio between the small radius and the large radius of the ellipsoid shape. More generally, shapes other than those mentioned above can be envisaged for the oblong transverse contour of the whole body 820. According to an advantageous aspect, if the filaments 821 are made of aramid, the ratio between the count of the thread 82 and the width l of its whole body 820 is lower than a predetermined value. This amounts to providing, for a given thread count, a thickness e of the whole body 820 that is small enough for the filaments 821 of this body to be distributed over a large width l. Thus, the aforementioned ratio is advantageously less than 1000 (thousand), when expressing the count of the non-coated whole body 820 in dtex and when expressing its width l, i.e. the length of its oblong contour, in millimeters. As the case may be, in the presence of coating material, in the form of the binder 822 and/or the sheath 823, the value of the aforementioned ratio remains relevant on the condition that the coating content is less than 50%.

### EXAMPLE 1

### Comparative Study of the Change According to Direction Under 3 lbs (1.36 kg) of Stress as a Function of Floating Time of a Coated Polyurethane Fabric and a Composite According to the Invention

The fabric consists of polyamide threads (55 threads/cm warp and 45 weft). This is a rip-stop weave. The weight is 45 g/m² (7 g/m² of polyurethane-melamine formaldehyde resin coating).

The composite comprises two aromatic polyether-based films of 25 μm, a polyester diamond-shaped mesh, and aramid threads 3300 dtex, with a thickness of 100 μm, sized with 30% adhesive (final count 4300 dtex), 4 threads per 5 cm. These threads are parallel to one another and are arranged so that they pass through the apex of the diamond shape. The stress is applied in the direction of the threads.

The fabric is characterized by a diagonal stiffness. The warp angle is at 45° with respect to the war threads. The weft angle is at 45° with respect to the weft threads. The elongation is measured in % under a force of 3 pounds (lbs, i.e. 1.36 kg) applied on the diagonal for the fabric and according to the direction of the aramid threads for the composite. This elongation characterizes the stiffness of the fabric on the diagonal. The standard used is NF EN ISO 13934-1: test samples with a width of 50 mm and a length of 300 mm are produced. The clamps of the dynamometer are separated by 200 mm and the measurement is performed at a rate of 100 mm/min. The measurements are performed on a new fabric (i.e. a fabric that has not been subject to aging) and on aged fabrics. The aging of the fabric is performed by floating the fabric fixed on a mill-type assembly at high speed (4-blade assembly, with the fabric being attached at the end of one of the blades).

The results are presented in FIG. 5. The results show that the composite according to the invention has a diagonal stretch that is much lower than the coated fabric of the prior art, even after aging. In addition, the results show that the elongation does not vary with the aging of the composite.

1. Composite comprising two polyurethane (PU) films, identical or different, which are connected to one another and between which a reinforcement mesh and at least one textile reinforcement thread oriented according to at least one predetermined stress line is inserted.

2. Composite according to claim 1, wherein the polyurethane is an aromatic or aliphatic polyether-based polyurethane.

3. Composite according to claim 1, wherein the polyurethane is an aliphatic polyester-based polyurethane.

4. Composite according to claim 1, wherein the PU films are connected to one another by welding.

5. Composite according to claim 1, wherein the PU films are connected to one another by lamination.

6. Composite according to claim 1, wherein the mesh has a mesh opening ranging from 2 to 20 mm.

7. Composite according to claim 1, wherein the mesh has a mesh opening ranging from 4 to 15 mm.

8. Composite according to claim 1, wherein a reinforcement fabric is placed inside the composite and arranged with respect to a portion of the composite.

9. Composite according to claim 8, wherein the fabric is laminated to the interior of the composite by a PU adhesive.

10. Sail including at least one composite according to claim 1.

11. Sail including at least one composite according to claim 4.

12. Sail including at least one composite according to claim 5.

13. Sail including at least one composite according to claim 8.

14. Sail according to claim 10, consisting of a flying sail.

15. Paraglide sail including a leading edge consisting of a composite according to claim 1, and/or including internal partitions consisting of a composite according to claim 1.

16. Paraglide sail including a leading edge consisting of a composite according to claim 1, and including suspended internal partitions consisting of a composite according to claim 1.

17. Sail according to claim 10, including suspended partitions made of a composite and including between 2 and 4 suspension lines per suspended partition.

18. Sail according to claims 10, including an upper portion and/or a lower portion formed entirely or partially by a PU film.

19. Sail according to claim 10, including composite swatches including reinforcement fabric forming areas connected by sewing and/or areas for attachment of suspension lines.
